(19) United States
(12) Patent Application Publication
(10) Pub. No.: US 2019/0185389 A1
(43) Pub. Date: Jun. 20, 2019

(54) Method for Binding Hazardous Agricultural Ammonia Using Organic Carbon Dioxide

(71) Applicants: PIETER ANTHONY PHILIP VAN WAKEREN, Wake Forest, NC (US); Egidijus Griskonis, KAUNAS (LT); Tomas Nakas, KAUNAS (LT)

(72) Inventors: PIETER ANTHONY PHILIP VAN WAKEREN, Wake Forest, NC (US); Egidijus Griskonis, KAUNAS (LT); Tomas Nakas, KAUNAS (LT)

(21) Appl. No.: 16/131,334

(22) Filed: Sep. 14, 2018

Related U.S. Application Data
(60) Provisional application No. 62/598,770, filed on Dec. 14, 2017.

(51) Int. Cl. C05C 3/00; C02F 9/00; C01C 1/26; C05F 3/00

(52) U.S. Cl. CPC C05C 3/00; C02F 9/00; C02F 1/385; C05F 3/00; C01C 1/26

(57) ABSTRACT

A method for binding hazardous agricultural ammonia using organic carbon dioxide reduces ammonia emissions from farming operations producing livestock, such as cows, pigs, and poultry. The method entraps a quantity of agricultural ammonia within an ammonia solution by reacting the quantity of agricultural ammonia with a quantity of organic carbon dioxide within a primary reaction vessel. The quantity of agricultural ammonia is mixed with a quantity of organic carbon dioxide to form an ammonia-bound solution. The ammonia-bound solution is able to be stored or transported for use in future chemical processes.

The current application claims a priority to the U.S. Provisional Patent application Ser. No. 62/598,770 filed on Dec. 14, 2017.

### FIELD OF THE INVENTION

The present invention relates generally to the reduction of hazardous gas emissions. More specifically, the present invention relates to the reduction of ammonia emissions from agricultural or industrial processes.

### BACKGROUND OF THE INVENTION

Currently, a limited amount of agricultural operations in the world use gas scrubbers to capture gaseous ammonia (NH₃) and bind it in the form of ammonium ions (NH₄⁺) using sulphuric acid H₂SO₄. This process is a non-organic chemical reaction that results in ammonium sulphate, a non-organic compound. Highly concentrated sulphuric acid is a serious chemical hazard in farming environments and is not sustainable for future agricultural technologies. As mentioned, a limited quantity of biologic gas scrubbers is currently in use on farms, primarily in Northern Europe. Processing the biological gas through a gas scrubber utilizes trickling filtration where nitrifying bacteria is grown to positively affect the nitrification of ammonia or ammonium ions within the biological gas into nitrate ions (NO₃⁻) into a carrier medium for transport. Attempts to capture/bind ammonia or ammonium ions (NH₃/NH₄⁺) successfully at commercial scale have been done in the EU, primarily in geographies such as The Netherlands, Belgium, Germany and Denmark, using sulphuric acid to produce ammonium sulphate salt when reacted with the ammonia or ammonium ions. In the Netherlands the capture of gaseous ammonia is required by law to reduce environmental impact of farming operations. In agricultural processes, gaseous ammonia is mostly emitted to the atmosphere. Ammonia and ammonium ions are valuable compounds especially captured and stored and made available for further processing in various industries.

The present invention is a method for binding hazardous agricultural ammonia using organic carbon dioxide. An object of the present invention is the capture of gaseous ammonia from fluid and gaseous states using carbon dioxide as a capturing, binding medium (carrier) and particularly relates to the treatment of liquids solutions or gases mixtures containing dissolved ammonia and ammonium ions to bind the ammonia or ammonium ions to produce ammonium bicarbonate ((NH₄)HCO₃), ammonium carbonate ((NH₄)₂CO₃) and ammonium carbamate (H₂NCOONH₄), or a combinations thereof. Excess ammonia is often created during the production of livestock, keeping livestock and other agricultural processes. In addition, ammonia is also a by-product for a plurality of industries including but not limited to petroleum refining or other specific chemical processes. Although the present invention focuses on capturing/binding ammonia or ammonium ions and forming ammonium carbonate, ammonium bicarbonate, and/or ammonium carbamate from livestock operations, the present invention can also be applied to alternative industrial settings with that produce an excess of ammonia or ammonium ions.

### BRIEF DESCRIPTION OF THE DRAWINGS

FIG. 1 is a flow diagram for the steps of the present invention.

FIG. 2 is a more specific flow diagram for the steps of the present invention.

FIG. 3 is a flow diagram for the steps of the present invention, wherein the present invention utilizes a centrifuge to separate the quantity of agricultural waste into a liquid waste fraction and a solid waste fraction.

FIG. 4 is a flow diagram for the steps of the present invention, wherein the present invention utilizes a micro-sieve membrane to separate the quantity of agricultural waste into a liquid waste fraction and a solid waste fraction.

FIG. 5 is a flow diagram for the steps of the present invention, wherein the present invention utilizes a gas scrubber to produce the ammonia solution.

### DETAIL DESCRIPTIONS OF THE INVENTION

All illustrations of the drawings are for the purpose of describing selected versions of the present invention and are not intended to limit the scope of the present invention.

The present invention is a method for binding hazardous agricultural ammonia using organic carbon dioxide. The formation of ammonia gas originates from farming operations producing livestock, such as cows, pigs, and poultry. The present invention removes agricultural ammonia from the atmosphere and allows for the storage and transport of ammonia for future applications. Implementation of the present invention allows a user to reduce emissions originating from said farming operations that focus on producing livestock, such as cows, pigs, or poultry. The present invention seeks to eliminate or reduce the environmental impact from these emissions.

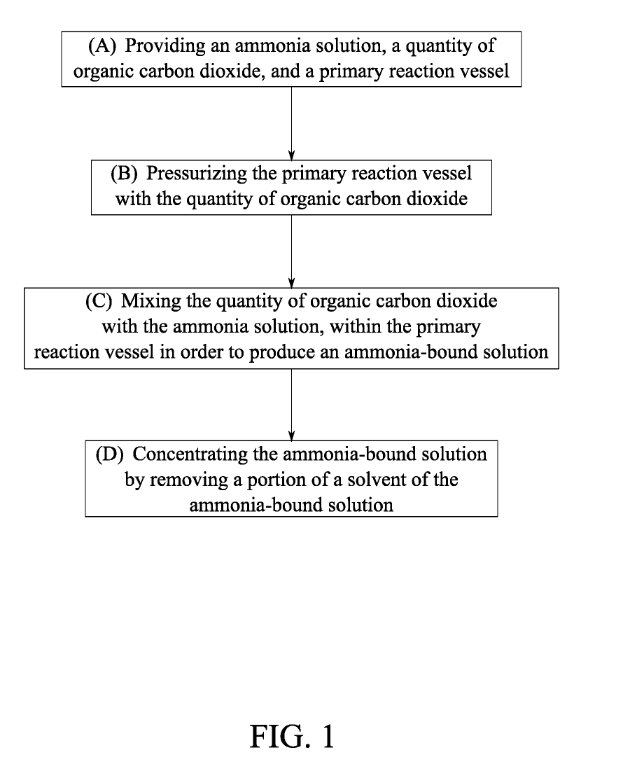

In order to execute the present invention, an ammonia solution, a quantity of organic carbon dioxide, and a primary reaction vessel are required (Step A), shown in FIG. 1. The ammonia solution is a source of ammonia collected from emissions from livestock farming. The ammonia solution comprises a quantity of aqueous ammonia, a quantity of ammonium ions, and a quantity of water. The quantity of organic carbon dioxide is the binding agent that reacts with the ammonia or ammonium ions within the ammonia solution to form an ammonia salt solution. The primary reaction vessel is a container that is chemically resistant to the ammonia solution such that the container does degrade as the ammonia solution is introduced and as the ammonia solution reacts with the quantity of organic carbon dioxide.

Initially, the primary reaction vessel is pressurized with the quantity of organic carbon dioxide in order to provide an initial concentration of organic carbon dioxide within the primary reaction vessel (Step B), in accordance to FIG. 1. The quantity of organic carbon dioxide is then mixed with the ammonia solution within the primary reaction vessel in order to produce an ammonia-bound solution (Step C). The ammonia-bound solution is a liquid solution that allows the transportation of the ammonia to be efficient locally or from site to site. The ammonia bound-solution is preferred to have a solute selected from the group consisting of ammonium bicarbonate ((NH₄)HCO₃), ammonium carbonate ((NH₄)₂CO₃), ammonium carbamate (H₂NCOONH₄), or combinations thereof. The ammonia-bound solution is then concentrated by removing a portion of the solvent of the ammonia-bound solution (Step D). Generally, the solvent is preferred to be water, due to the favorably solubility properties of ammonia and ammonium salts with water.

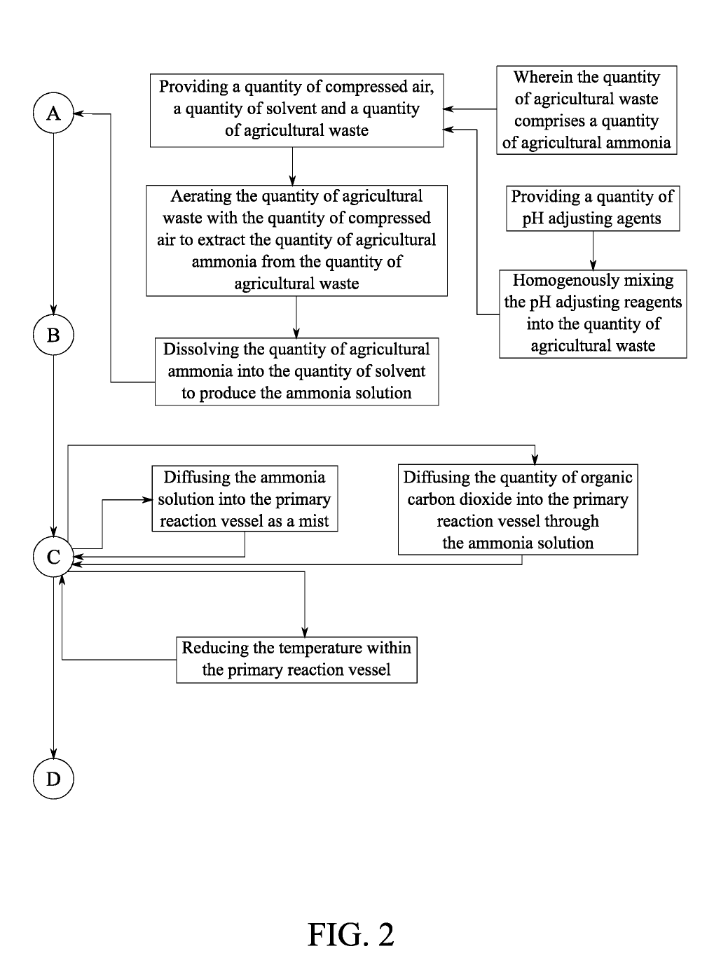

In some embodiments of the present invention, the temperature within the primary reaction vessel is reduced using a heat exchanger, during Step C, shown in FIG. 2. By reducing the temperature, the aqueous ammonia within the ammonia-bound solution has a decreased tendency to for the aqueous ammonia to transition into the gas phase. Therefore, the aqueous ammonia is retained in the ammonia-bound solution to be transported or stored for future applications.

Further in accordance to the preferred embodiment, the aqueous ammonia, and the ammonium ions of the ammonia solution are obtained from a quantity of agricultural waste using a quantity of compressed air. Detailed in FIG. 2, the quantity of agricultural waste comprises a quantity of agricultural ammonia. Prior to Step A, the quantity of agricultural waste is aerated with the quantity of compressed air to extract the quantity of from the quantity of agricultural waste. This extraction process utilizes the convection of the quantity of compressed air from the aeration to transition the quantity of agricultural ammonia into the gaseous phase. The quantity of gaseous ammonia is then dissolved into a quantity of solvent to produce the ammonia solution.

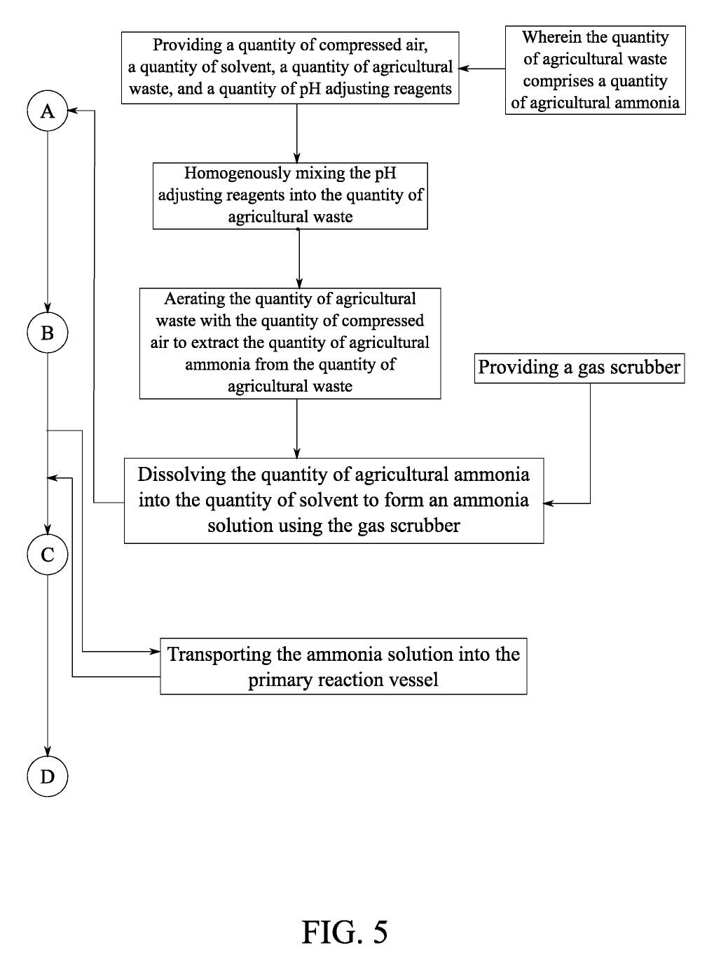

Still in accordance to the preferred embodiment, a quantity of pH adjusting reagent is utilized to reduce potential corrosion of equipment and increase the ease which the ammonia evaporates during to the aeration of the quantity of agricultural waste. Detailed in FIG. 2 and FIG. 5, the quantity of pH adjusting reagent is homogenously mixed with the quantity of agricultural waste, prior to the aeration of the quantity of agricultural waste, such that the quantity of pH adjusting reagent favorably adjusts the level of acidity of the quantity of agricultural waste. The adjustment to the pH of the quantity of agricultural waste shifts the concentration of the quantity of ammonia, such that the quantity of ammonia is more amenable to the aeration process to produce a higher yield of the ammonia solution.

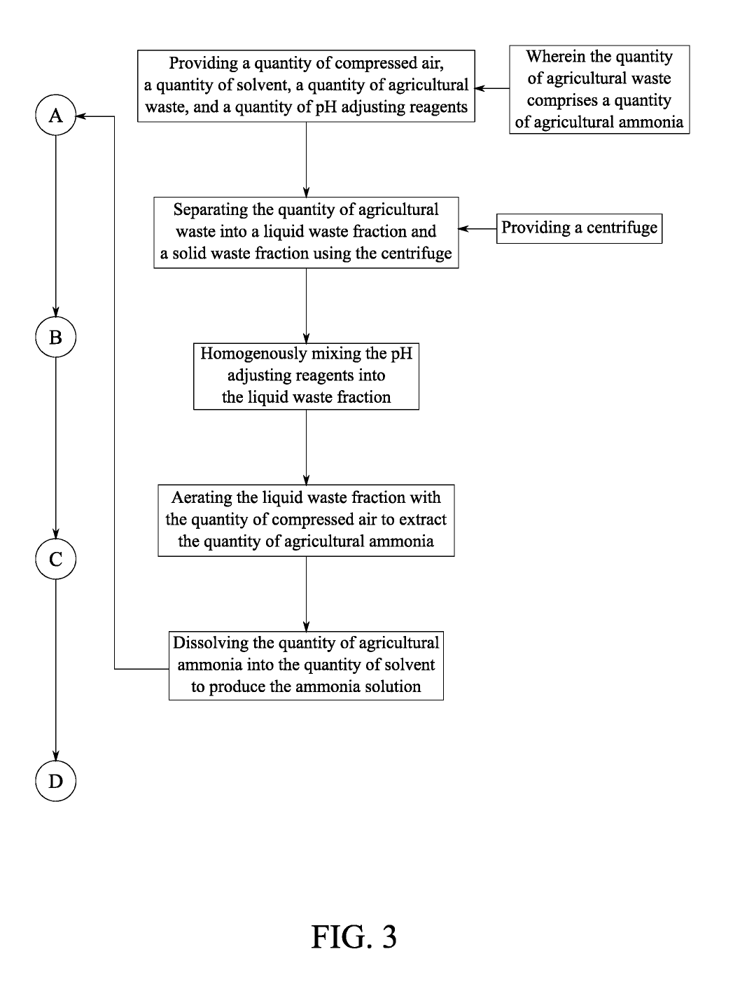

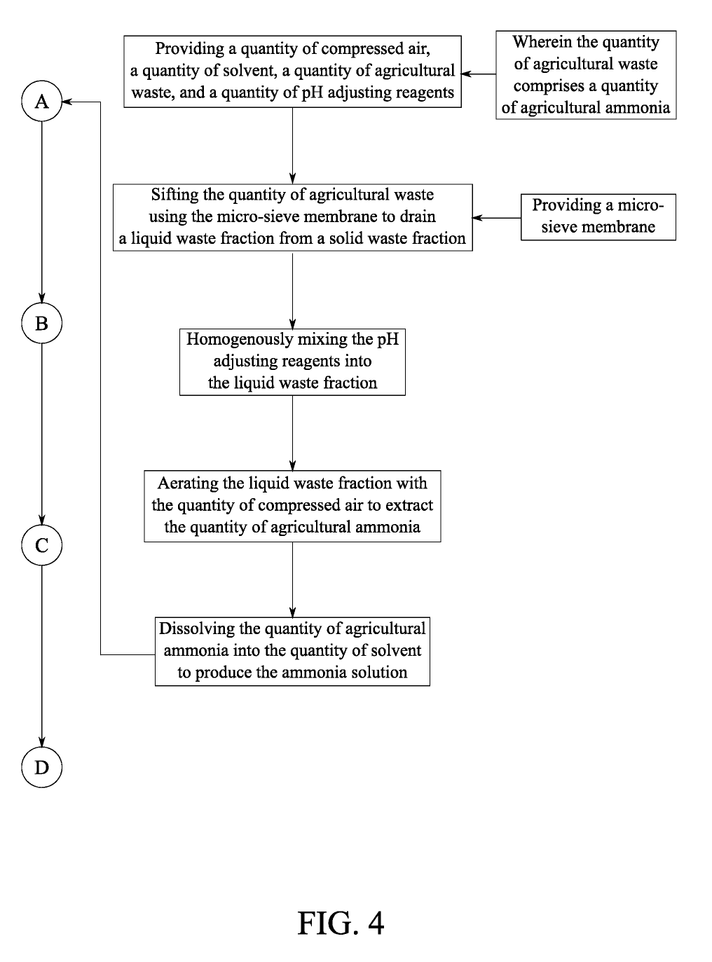

For a more specific embodiment of the present invention, the present invention utilizes a centrifuge to separate the quantity of agricultural waste, such that the extraction of the quantity of agricultural ammonia is more efficient, shown in FIG. 3. The quantity of agricultural waste is separated into a liquid waste fraction and a solid waste fraction. The quantity of agricultural ammonia is present in both the liquid waste fraction and the solid waste fraction; however; there is a negligible presence within the solid waste fraction. Once the liquid waste fraction is decanted from the solid waste fraction, the liquid waste fraction is then aerated withed the quantity of compressed air to extract the quantity of agricultural ammonia. For an alternate embodiment of the present invention, the present invention utilizes a micro-sieve membrane to accomplish the separation of the liquid waste fraction and the solid waste fraction, detailed in FIG. 4. The quantity of agricultural waste is sifted using the micro-sieve membrane to drain the liquid waste fraction from the solid waste fraction. The liquid waste fraction is then similarly aerated with the quantity of compressed air to extract the quantity of agricultural ammonia. In accordance to a specific embodiment of the present invention, the quantity pH adjusting reagent is homogenously mixed with the liquid waste fraction, prior to the aeration of the liquid waste fraction, shown in FIG. 3 and FIG. 4. Thus, the quantity of ammonia within the liquid waste fraction is readily extracted during the aeration of the liquid waste fraction.

Once the quantity of agricultural ammonia is aerated into the gaseous phase or if the quantity of agricultural ammonia is already present in the gaseous phase, the quantity of agricultural ammonia is dissolved into the quantity of solvent. In accordance to FIG. 5, a gas scrubber and the quantity of solvent are utilized to form the ammonia solution. The quantity of agricultural ammonia is dissolved into the quantity of solvent to form the ammonia solution using the gas scrubber. The gas scrubber forces the quantity of agricultural ammonia into the solvent to allow the quantity of agricultural ammonia to be removed from the atmosphere. The ammonia solution is then transported to the primary reaction vessel, using a liquid pump.

In some embodiments of the present invention the ammonia solution is diffused into the primary reaction vessel as a mist, during Step C, shown in FIG. 2. By diffusing the ammonia solution as a mist, the interface surface area that the quantity of organic carbon dioxide is able to be in contact with the ammonia solution is increased. Therefore, the reaction rate to produce the ammonium-bound solution is increased. In an alternate embodiment of the present invention, the quantity of organic carbon dioxide is diffused into the primary reaction vessel through the ammonia solution to similarly increase the interface surface area between the ammonia solution and the quantity of organic carbon dioxide, during Step C, detailed in FIG. 2. Additionally, the quantity of organic carbon dioxide is pumped through the bottom of the primary reactor vessel to pressurize the primary reactor vessel.

After the ammonia-bound solution is concentrated during Step D, the ammonia-bound solution is able to be stored or utilized in future chemical processes. For future chemical processes that require ammonia, the ammonia-bound solution is heated to separate the ammonia-bound solution into a quantity of ammonia product, a quantity of carbon dioxide product, and a quantity of water product, in accordance to FIG. 2.

For an exemplary implementation of the present invention, a farm produces pigs and primarily utilizes a gas scrubber to capture the quantity of agricultural ammonia emissions. A quantity of compressed air is used to force evaporate the quantity of agricultural ammonia from a liquid waste fraction from the agricultural waste, pig manure, that was previously separated into a liquid waste fraction and a solid waste fraction with a centrifuge. The quantity of agricultural ammonia from the liquid waste fraction then is processed via the gas scrubber to dissolve the quantity of agricultural ammonia in the quantity of solvent, preferably water, to form the ammonia solution. The primary reaction vessel is charged with quantity of organic carbon dioxide. The quantity of agricultural ammonia is introduced into the primary reaction vessel via spraying the ammonia solution from the gas scrubber into the primary reaction vessel. The quantity of organic carbon dioxide reacts with the ammonia solution to form the ammonia-bound solution, where the ammonia-bound solution is a combination of ammonium bicarbonate, ammonium carbonate, and ammonium carbamate. The ammonia-bound solution is then concentrated and transported to a processing facility where the ammonia-bound solution can be further utilized in the creation of valuable compounds and products such as organic fertilizer.

In another exemplary implementation of the present invention, a farming operation produces poultry eggs and utilizes the present invention to obtain the ammonia-bound solution from chicken litter composting operations. The present invention can introduce and increase or optimize the farm's revenue, as well as reduce its environmental impact. The evaporation for the quantity of agricultural ammonia can be stimulated by introducing composting systems to compost chicken litter. Composting of chicken litter force evaporates and ferments chicken litter that results in useful organic chicken compost fertilizer and a gaseous quantity of agricultural ammonia. The evaporated quantity of agricultural ammonia can be controlled within an enclosed environment and captured by using gas scrubbers. The gaseous quantity of agricultural ammonia is dissolved in the quantity of solvent, water, due to its high solubility. The ammonia solution is transported into the primary reactor vessel where the ammonia solution is bound by the quantity of organic carbon dioxide forming the ammonia-bound solution, where the ammonia-bound solution is a combination of ammonium bicarbonate, ammonium carbonate, and ammonium carbamate. The ammonia-bound solution is comprised of valuable compounds which can be sold for further industrial processing.

In still another exemplary implementation of the present invention, a farming operation produces pigs, and subsequently large amounts of pig manure with the potential to add revenue by producing the ammonia-bound solution and reduce odor emissions simultaneously. The farming operation introduces separation of the pig manure in a liquid waste fraction and a solid waste fraction using reverse osmosis through the micro-sieve membrane. The quantity of compressed air aerates a liquid waste fraction and force evaporates the quantity of agricultural ammonia. The quantity of agricultural ammonia is transported through the quantity of solvent to for the ammonia solution. The ammonia solution is circulated into the primary reactor vessel to form ammonia-bound solution with the quantity of organic carbon dioxide, wherein the ammonia-bound solution is a combination of ammonium bicarbonate, ammonium carbonate, and ammonium carbamate.

Although the invention has been explained in relation to its preferred embodiment, it is to be understood that many other possible modifications and variations can be made without departing from the spirit and scope of the invention as hereinafter claimed.

What is claimed is:

1. A method for binding hazardous agricultural ammonia using organic carbon dioxide comprises the steps of:
(A) providing an ammonia solution, a quantity of organic carbon dioxide, and a primary reaction vessel;
(B) pressurizing the primary reaction with the quantity of organic carbon dioxide;
(C) mixing the quantity of organic carbon dioxide with the ammonia solution, within the primary reaction vessel in order to produce an ammonia-bound solution; and
(D) concentrating the ammonia-bound solution by removing a portion of a solvent of the ammonia-bound solution.

2. The method for binding hazardous agricultural ammonia using organic carbon dioxide, as claimed in claim 1, comprises the steps of:
providing a quantity of compressed air, a quantity of solvent, and a quantity of agricultural waste, wherein the quantity of agricultural waste comprises a quantity of agricultural ammonia;
aerating the quantity of agricultural waste with the quantity of compressed air to extract the quantity of agricultural ammonia from the quantity of agricultural waste, prior to Step A; and
dissolving the quantity of agricultural ammonia into the quantity of solvent to produce the ammonia solution.

3. The method for binding hazardous agricultural ammonia using organic carbon dioxide, as claimed in claim 3, comprises the steps of:
providing a quantity of pH adjusting reagents;
homogenously mixing the quantity pH adjusting reagents into the quantity of agricultural waste, prior to the aeration of the quantity of agricultural waste;

4. The method for binding hazardous agricultural ammonia using organic carbon dioxide, as claimed in claim 3, comprises the steps of:
providing a centrifuge;
separating the quantity of agricultural waste into a liquid waste fraction and a solid waste fraction using the centrifuge; and
aerating the liquid waste fraction with the quantity of compressed air to extract the quantity of agricultural ammonia.

5. The method for binding hazardous agricultural ammonia using organic carbon dioxide, as claimed in claim 4, comprises the steps of:
providing a quantity of pH adjusting reagents;
homogenously mixing the quantity pH adjusting reagents into the liquid waste fraction, prior to the aeration of the liquid waste fraction;

6. The method for binding hazardous agricultural ammonia using organic carbon dioxide, as claimed in claim 3, comprises the steps of:
providing a micro-sieve membrane;
sifting the quantity of agricultural waste using the micro-sieve membrane to drain a liquid waste fraction from a solid waste fraction; and
aerating the liquid waste fraction with the quantity of compressed air to extract the quantity of agricultural ammonia.

7. The method for binding hazardous agricultural ammonia using organic carbon dioxide, as claimed in claim 6, comprises the steps of:
providing a quantity of pH adjusting reagents;
homogenously mixing the quantity pH adjusting reagents into the liquid waste fraction, prior to the aeration of the liquid waste fraction;

8. The method for binding hazardous agricultural ammonia using organic carbon dioxide, as claimed in claim 3, comprises the steps of:
providing a gas scrubber;
dissolving the quantity of agricultural ammonia into the quantity of solvent to form an ammonia solution using the gas scrubber; and
transporting the ammonia solution into the primary reaction vessel.

9. The method for binding hazardous agricultural ammonia using organic carbon dioxide, as claimed in claim 1, comprises the step of:
reducing the temperature within the primary reaction vessel, during Step C.

10. The method for binding hazardous agricultural ammonia using organic carbon dioxide, as claimed in claim 1, comprises the step of:
diffusing the ammonia solution into the primary reaction vessel as a mist, during Step C.

11. The method for binding hazardous agricultural ammonia using organic carbon dioxide, as claimed in claim 1, comprises the step of:
diffusing the quantity of organic carbon dioxide into the primary reaction vessel through the ammonia solution, during Step C.

12. The method for binding hazardous agricultural ammonia using organic carbon dioxide, as claimed in claim 1, wherein a solute of the ammonia-bound solution is selected from the group consisting of ammonium bicarbonate, ammonium carbonate, ammonium carbamate, or combinations thereof.

13. The method for binding hazardous agricultural ammonia using organic carbon dioxide, as claimed in claim 1, wherein the ammonia solution comprises a quantity of aqueous ammonia, a quantity of ammonium ions, and a quantity of water.
